(19) United States
(12) Patent Application Publication
(10) Pub. No.: US 2025/0028572 A1
(43) Pub. Date: Jan. 23, 2025

(54) METHODS AND APPARATUS TO TAG CLOUD RESOURCES

(71) Applicant: VMware LLC, Palo Alto, CA (US)

(72) Inventors: MANISH JAIN, Faridabad (IN); VISHAL GUPTA, Ludhiana (IN); PRANALI LOKARE, Pune (IN); SIDDHARTH BURLE, Pune (IN); AMIT MEENA, Pune (IN)

(21) Appl. No.: 18/376,456

(22) Filed: Oct. 4, 2023

(30) Foreign Application Priority Data
Jul. 20, 2023 (IN) 202341048937

(51) Int. Cl. G06F 9/50

(52) U.S. Cl. CPC G06F 9/5077; G06F 9/5072

(57) ABSTRACT

Systems, apparatus, articles of manufacture, and methods are disclosed to tag cloud resources. An example apparatus includes interface circuitry, machine readable instructions, and programmable circuitry to at least one of instantiate or execute the machine readable instructions to obtain first accesses of a cloud resource, the first accesses defining a first usage pattern associated with the cloud resource, associate the cloud resource with a business environment based on the first accesses, compare the first usage pattern to a second usage pattern corresponding to historical accesses of reference cloud resources associated with the business environment, and when the first usage pattern is different from the second usage pattern, limit second accesses of the cloud resource based on the second usage pattern.

### RELATED APPLICATIONS

Benefit is claimed under 35 U.S.C. 119(a)-(d) to Foreign Application Serial No. 202341048937 filed in India entitled “METHODS AND APPARATUS TO TAG CLOUD RESOURCES”, on Jul. 20, 2023, by VMware, Inc., which is herein incorporated in its entirety by reference for all purposes.

### FIELD OF THE DISCLOSURE

This disclosure relates generally to cloud resources and, more particularly, to methods and apparatus to tag cloud resources.

### BACKGROUND

Cloud computing is based on the delivery of computing resources including storage, processing power, databases, networking, analytics, artificial intelligence, and software applications via a networked data center. Cloud servers may include compute, memory, and/or storage resources to remotely perform services and functions for an organization.

### BRIEF DESCRIPTION OF THE DRAWINGS

FIG. 1 is a block diagram of an example environment in which example resource manager circuitry can be implemented.

FIG. 2 is an example schematic that can be implemented by the example resource manager circuitry of FIG. 1.

FIG. 3 illustrates an example sequence diagram that can be implemented by the example resource manager circuitry of FIG. 1.

FIGS. 4 and 5 are flowcharts representative of example machine readable instructions and/or example operations that may be executed, instantiated, and/or performed by example programmable circuitry to implement the resource manager circuitry of FIG. 1.

FIG. 6 is a block diagram of an example processing platform including programmable circuitry structured to execute, instantiate, and/or perform the example machine readable instructions and/or perform the example operations of FIGS. 4 and 5 to implement the resource manager circuitry 101 of FIG. 1.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4 and 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

With demands for cloud computing increasing, incentives for optimizing allocation of cloud resources increase. Cloud computing is based on the deployment of many physical resources across a network, virtualizing the physical resources into virtual resources, and provisioning the virtual resources to perform cloud computing resources and applications. Cloud automation tools or services reduce the creation and deployment complexity of virtual machines, computing services, and applications in a given cloud computing infrastructure. Some such cloud automation tools automate the deployment, orchestration, governance, extensibility, and management of resources in a cloud infrastructure.

In some examples, a customer of the cloud automation tool can use resources provided by different cloud providers (e.g., Google Cloud Platform (GCP), Amazon Web Services (AWS), Microsoft Azure, etc.) for different deployments. However, large-scale use of such cloud resources can inhibit the efficient deployment and use of these resources which, in turn, can result in data breaches or excess use of cloud resources.

Methods and apparatus to tag cloud resources are disclosed herein. Examples disclosed herein track, monitor, and manage cloud resources. For example, disclosed methods tag resources to provide a user or an organization with a comprehensive, centralized view of cloud resources. Such a centralized view enables the user to identify overuse, duplicative use, security breaches, policy compliance, etc. Further, examples disclosed herein provide organizations with a centralized view of which employees or departments have access to cloud resources. Thus, examples disclosed herein improve transparency and accessibility into the usage of these cloud resources.

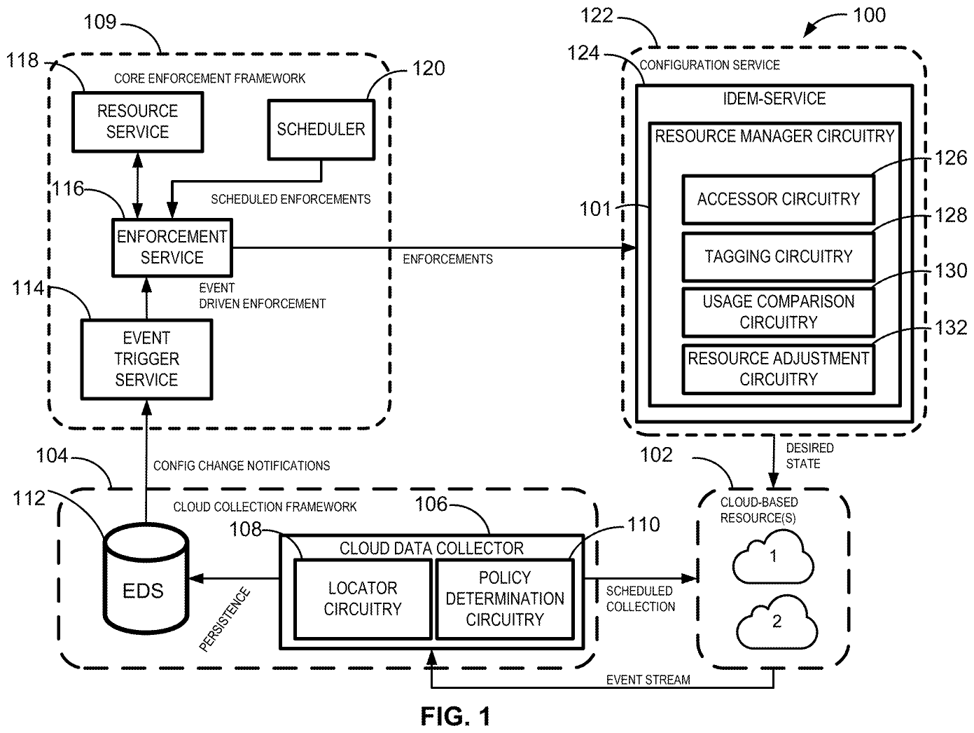

FIG. 1 is a schematic block diagram of an example environment 100 in which example resource manager circuitry 101 operates to manage access and/or utilization of cloud resources an example cloud environment. In the illustrated example of FIG. 1, aspects and/or components of the environment 100 function as a system that manages operations and usage of at least one cloud-based resource 102. The management of the operations can pertain to configuring settings, managing resource usage and/or managing accesses of the cloud-based resource(s) 102. As used herein, “accesses” refers to consumption activities of the cloud-based resource(s) 102 and/or reference cloud-based resource(s). For example, an example access can represent a request to store/edit/view an example file in the cloud-based resource(s) 102. In other examples, an access can indicate that an example user has entered credentials (or signed in) to use/access the cloud-based resource(s) 102. The example architecture shown in the example of FIG. 1 is only an example and any appropriate other architecture, network, control scheme, communication and/or data topology can be implemented instead.

According to examples disclosed herein, an example cloud collection framework 104 includes an example cloud data collector 106 to coordinate and communicate with the cloud-based resource(s) 102. To that end, the example cloud data collector 106 can extract, receive and/or query information (e.g., components, metadata, services, service information, etc.) from the cloud-based resource(s) 102. In this example, the cloud data collector 106 can request and/or direct the cloud-based resource(s) 102 to provide information related to: (1) accounts (or people) utilizing the cloud-based resource(s) 102, (2) at least one configuration of the cloud-based resource(s) 102 and/or (3) services of the cloud-based resource(s) 102. The request by the cloud data collector 106 to the cloud-based resource(s) 102 can be driven by an occurrence of an event or performed on periodic or aperiodic timeframes and/or on a schedule. According to examples disclosed herein, the cloud-based resource(s) 102 provide(s) data, requested changes, configuration information and/or updates associated with the cloud-based resource(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based resource(s) 102 and/or operational data of the cloud-based resource(s) 102.

The example cloud data collector 106 includes example locator circuitry 108 and example policy determination circuitry 110. The example locator circuitry 108 can determine a location of an example computing device accessing the cloud-based resource(s) 102. For example, the locator circuitry 108 can access an example Internet Protocol (IP) address or other device identifier to determine a location (e.g., state, geographic region, country, etc.) corresponding to the accesses of the cloud-based resource(s) 102. In turn, the example policy determination circuitry 110 can access the location of the example computing device to determine example policies (e.g., policy instructions, compliance instructions, security standards, etc.) to enforce on the cloud-based resource(s) 102. For example, when the locator circuitry 108 determines that the cloud-based resource(s) 102 was (were) deployed in the European Union (EU), the policy determination circuitry 110 can determine enforcement instructions for the cloud-based resource(s) 102 in compliance with the General Data Protection Regulation (GDPR) standards. Additionally or alternatively, when the locator circuitry 108 determines that the cloud-based resource(s) 102 was (were) deployed in Australia, the policy determination circuitry 110 can determine enforcement instructions for the cloud-based resource(s) 102 in compliance with the Australian Privacy Principals (APPs). In other examples, when the locator circuitry 108 determines that the cloud-based resource(s) 102 was (were) deployed in the United States (US), the policy determination circuitry 110 can determine enforcement instructions for the cloud-based resource(s) 102 in compliance with the Health Insurance Portability and Accountability Act (HIPAA) standards (if the cloud-based resource(s) 102 are associated with healthcare data) or Family Educational Rights and Privacy Act (FERPA) standards (if the cloud-based resource(s) 102 are associated with education data). Further, when the locator circuitry 108 determines that the cloud-based resource(s) 102 was (were) deployed in Canada, the policy determination circuitry 110 can determine enforcement instructions for the cloud-based resource(s) 102 in compliance with the Personal Information Protection and Electronic Documents Act (PIPEDA) standards.

Further, the example policy determination circuitry 110 can determine industry policies to enforce on the cloud-based resource(s) 102. For example, the cloud data collector 106 can extract metadata from the cloud-based resource(s) 102 pertaining to financial services (e.g., investment or banking activities) and, in turn, the policy determination circuitry 110 can determine enforcement instructions for the cloud-based resource(s) 102 in compliance with the Sarbanes-Oxley Act (SOX) standards or the Payment Card Industry Data Security Standards (PCI-DSS).

In this example, the aforementioned cloud collection framework 104 also includes an example entity data service (EDS) 112. The example EDS 112 can be implemented as a database, data store, database manager and/or database framework to store and/or collect data associated with the cloud-based resource(s) 102. The example EDS 112 stores entity data of the cloud-based resource(s) 102 in a normalized form (e.g., as a centralized repository). For example, the EDS 112 stores the location information (e.g., IP address(es), geographic location(s), etc.) from the locator circuitry 108 and the enforcement instructions from the policy determination circuitry 110. Additionally or alternatively, the example EDS 112 stores data associated with historical accesses of the cloud-based resource(s) 102. As used herein, “historical accesses” refers to previous consumption activities of the cloud-based resource(s) 102 and/or reference cloud-based resource(s). For example, historical accesses of the reference cloud-based resources can indicate workload capacity, resource cost, or business context associated with the reference cloud-based resources. As used herein, the terms “business context,” “business environment,” or “business strategy” refers to internal business objectives or concerns of an example organization (e.g., VMware). For example, an example business context can indicate an example environment (e.g., production, development), an example data security classification (e.g., private or public), an example technical attribute (e.g., operating system, application type, etc.), an example organizational attribute (e.g., project name, cost center, department, owner, working/active hours, etc.), etc. In some examples, the EDS 112 accesses the business context(s) for the cloud-based resource(s) 102 from external sources (e.g., vRealize Network Insight (vRNI), vRealize Operations (vROPS), Ensemble, etc.).

According to examples disclosed herein, the EDS 112 can provide any requested or proposed configuration change request to a core enforcement framework 109 which, in turn, includes an example event trigger service 114 that implements an example enforcement service 116, an example resource service 118 and an example scheduler 120. For example, when an event occurs, such as a rule change and/or a configuration change corresponding to the cloud-based resource(s) 102, a notification from the EDS 112 is provided to the event trigger service 114.

The event trigger service 114 of the illustrated example is implemented to direct enforcement, configuration changes and/or access to services (e.g., microservices) of the cloud-based resource(s) 102. The example event trigger service 114 can map a configuration change event to a desired state of the cloud resource(s). Accordingly, the example event trigger service 114 can direct control, usage and/or configuration of the cloud-based resource(s) 102 via (or in conjunction with) the aforementioned enforcement service 116. In this example, the event trigger service 114 provides requests and/or commands pertaining to event-driven enforcement of the cloud-based resource(s) 102 to the enforcement service 116. In some examples, the event trigger service 114 manages and/or directs changes to key value data stores. In some examples, the event trigger service 114 can utilize and/or implement a Kubernetes cluster.

The example enforcement service 116 determines, manages and provides enforcements (e.g., configuration changes, access changes, resource usage instructions, a desired state change, etc.) with respect to the cloud-based resource(s) 102 to a configuration service 122 based on the event-driven enforcements and/or instructions received from the event trigger service 114. Additionally or alternatively, notifications (e.g., configuration change notifications), enforcements and/or instructions received from the resource service 118 and the scheduler 120 cause the enforcement service 116 to provide enforcements to the configuration service 122. In turn, the enforcements provided to the configuration service 122 are subsequently provided to the cloud-based resource(s) 102 as desired state changes (e.g., desired state change instructions or directives).

In this example, the resource service 118 stores and/or manages operational data and/or settings of the cloud-based resource(s) 102. In this example, the resource service 118 contains, analyzes and/or manages metadata of the cloud-based resources(s) 102 that is utilized to manage the cloud-based resource(s) 102. In particular, the metadata corresponds to settings, access information and/or configurations of the cloud-based resource(s) 102. For example, the access information can include times (e.g., daytime) the cloud-based resource(s) 102 were accessed (e.g., launched, used, etc.) by an example user and/or an example device. Further, the access information can include files or data associated with the accesses.

In some examples, the aforementioned scheduler 120 directs and/or manages scheduled implementations, configuration changes, enforcements and/or updates (e.g., periodic updates) of the cloud-based resource(s) 102 via the example enforcement service 116 and the configuration service 122. For example, the scheduler 120 can schedule the enforcement service 116 to perform scheduled enforcements of the configuration service 122 which, in turn, controls and/or directs a desired state of the cloud-based resource(s) 102.

To control, manage, enforce and/or direct operation of the cloud-based resource(s) 102, as mentioned above, the example enforcement service 116 provides the enforcements to the configuration service 122. In this example, the configuration service 122 includes an idempotent (IDEM) service 124 that is distinct from the core enforcement framework 109 and, thus, the enforcement service 116. However, the IDEM service 124 can be integrated with the enforcement service 116 and/or the core enforcement framework 109 in other examples. In the illustrated example of FIG. 1, the IDEM service 124 is an implementation/provisioning engine that implements desired state changes with respect to the cloud-based resource(s) 102. In other words, the IDEM service 124 controls a desired state of the cloud-based resource(s) 102 based on enforcements provided from the enforcement service 116. While the resource manager circuitry 101 is shown implemented in the IDEM service 124, additionally or alternatively, the resource manager circuitry 101 can be implemented in the event trigger service 114, the enforcement service 116, the resource service 118 and/or the scheduler 120.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud resources, examples disclosed herein can be implemented in conjunction with any appropriate distributed and/or shared computing resource system.

The example resource manager circuitry 101 includes example accessor circuitry 126, example tagging circuitry 128, example usage comparison circuitry 130, and example resource adjustment circuitry 132. The resource manager circuitry 101 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the resource manager circuitry 101 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

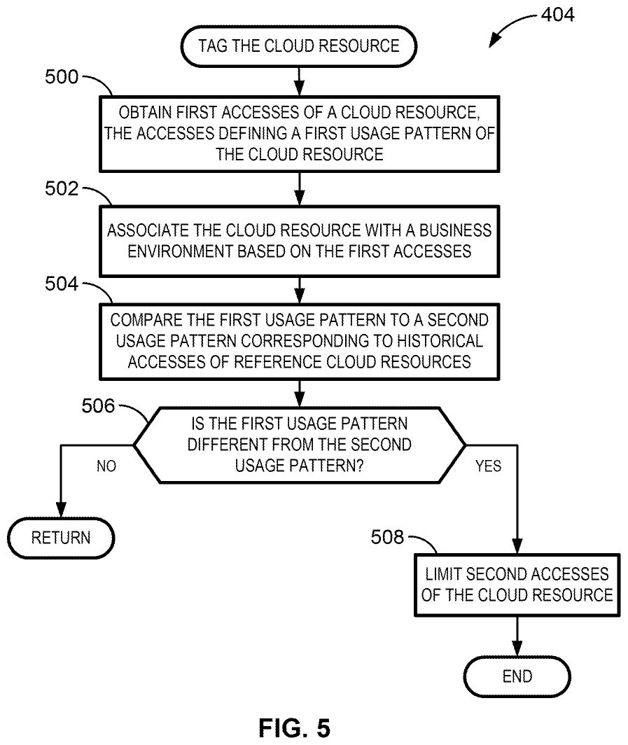

The example accessor circuitry 126 obtains first accesses of an example cloud resource (e.g., one of the cloud-based resource(s) 102, an Amazon Elastic Compute Cloud (EC2) instance, an Amazon Simple Storage Service (S3) bucket, an Amazon Relational Database Service (RDS) database, etc.). The example accessor circuitry 126 accesses information pertaining to the first accesses of the cloud-based resource(s) 102 from the resource service 118. As such, the example accessor circuitry 126 can access a usage pattern (e.g., hours of active use) defined by the first accesses of the example cloud resource. As used herein, a “usage pattern” refers to example metrics associated with example accesses of an example cloud-based resource. For example, an example usage pattern can indicate how often (or if) a user entered credentials to access an example cloud resource. Further, a usage pattern can indicate a number of hours a user or a computing device accessed an example cloud resource, a number of hours (or amount of power) an example CPU of a computing device was used to access the example cloud resource, cost metrics associated with the accesses of the example cloud resource, geographic locations associated with the accesses of the example cloud resource, etc. In some examples, the accessor circuitry 126 is instantiated by programmable circuitry executing accessing instructions and/or configured to perform operations such as those represented by the flowchart of FIG. 5.

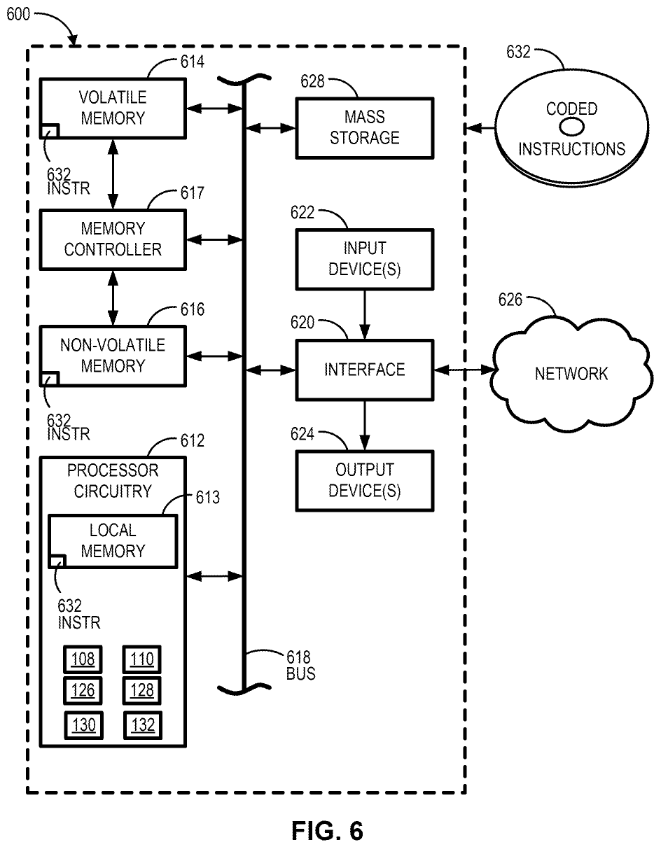

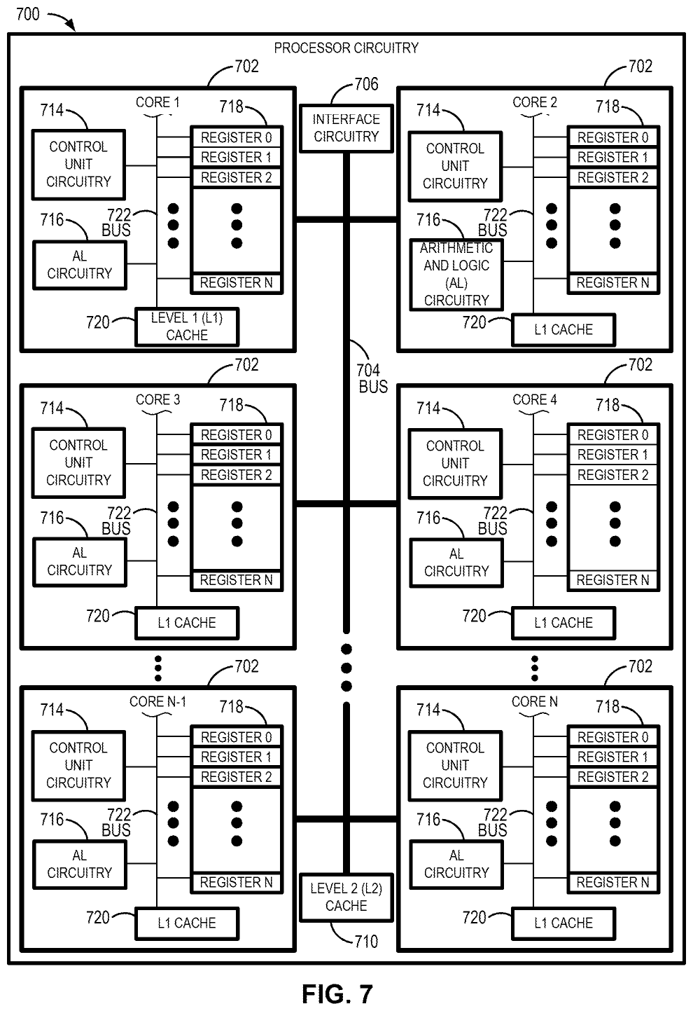

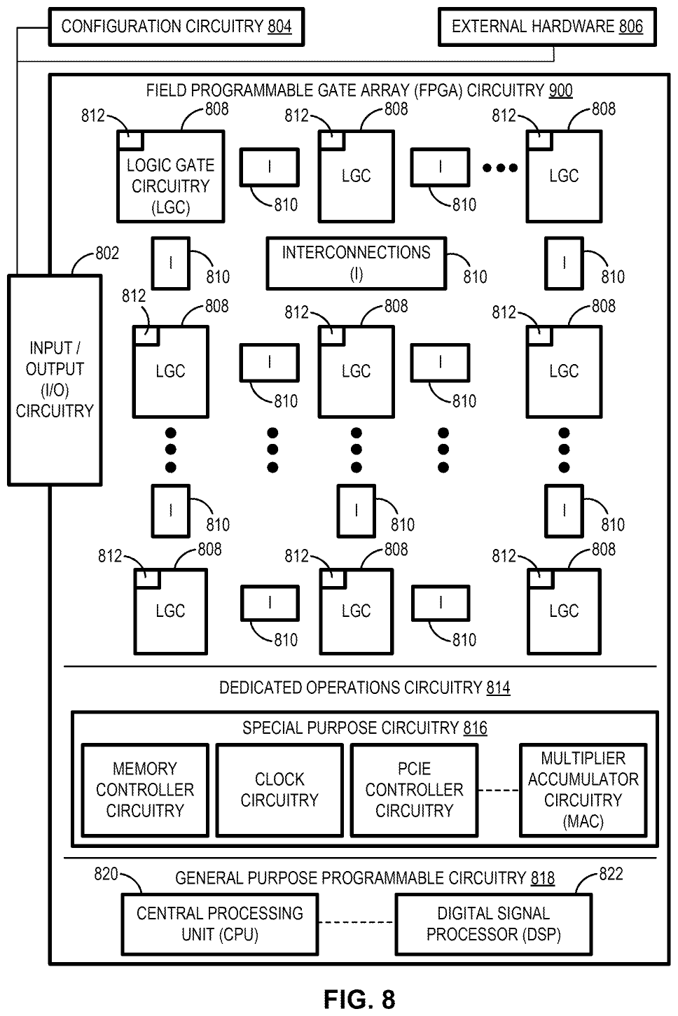

In some examples, the resource manager circuitry 101 includes means for accessing. For example, the means for accessing may be implemented by accessor circuitry 126. In some examples, the accessor circuitry 126 may be instantiated by programmable circuitry such as the example programmable circuitry 612 of FIG. 6. For instance, the accessor circuitry 126 may be instantiated by the example microprocessor 700 of FIG. 7 executing machine executable instructions such as those implemented by at least block 500 of FIG. 5. In some examples, the accessor circuitry 126 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the accessor circuitry 126 may be instantiated by any other combination of hardware, software, and/or firmware. For example, the accessor circuitry 126 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example tagging circuitry 128 associates the example cloud resource with a business environment based on the first accesses. In some examples, the files or data associated with the first accesses can relate to healthcare data. For example, employees who work for a healthcare network may access an example cloud-based resource (e.g., Amazon S3 bucket) to save or edit files (e.g., patient data). As such, the example tagging circuitry 128 can associate the example cloud resource with a healthcare business environment. In other words, the example tagging circuitry 128 can tag the example cloud resource with a “healthcare tag.” In some examples, the tagging circuitry 128 associates the cloud resource with a data security classification (e.g., private or public). For example, some accounts may be authorized to access patient data while other accounts may not be authorized to access patent data. The first example accesses may indicate that login credentials (or access codes) are needed to access the patient data. Accordingly, the example tagging circuitry 128 can associate the example cloud resource with a data security classification of “private.” In other words, the example tagging circuitry 128 can tag the example cloud resource with a “private” or “confidential” tag.

In some examples, the tagging circuitry 128 can determine (e.g., detect) changes to the tags. For example, a user of the example cloud resource may manually (or accidentally) attempt to change the “healthcare tag” to a “finance tag.” In some examples, the user of the example cloud resource may be a creator, owner, authorized user, etc., of the example cloud resource. However, the user of the example cloud resource may be an unauthorized user of the example cloud resource. In such examples, the tagging circuitry 128 can prevent (e.g., override, limit, etc.) changes to and/or deletions of tags. As such, the example tagging circuitry 128 can maintain the initial/original tags. In some examples, the tagging circuitry 128 can transmit the tags to the event trigger service 114 and/or the enforcement service 116 to enforce (e.g., maintain, prevent changes to, etc.) the initial tags determined by the tagging circuitry 128. In other words, the example tagging circuitry 128 can determine a desired state of tags associated with the example cloud resource. Accordingly, the event trigger service 114 and/or the enforcement service 116 can maintain the desired state of the tags determined by the tagging circuitry 128. In some examples, the tagging circuitry 128 is instantiated by programmable circuitry executing tagging instructions and/or configured to perform operations such as those represented by the flowchart of FIG. 5.

In some examples, the resource manager circuitry 101 includes means for associating. For example, the means for associating may be implemented by tagging circuitry 128. In some examples, the tagging circuitry 128 may be instantiated by programmable circuitry such as the example programmable circuitry 612 of FIG. 6. For instance, the tagging circuitry 128 may be instantiated by the example microprocessor 700 of FIG. 7 executing machine executable instructions such as those implemented by at least block 502 of FIG. 5. In some examples, the tagging circuitry 128 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the tagging circuitry 128 may be instantiated by any other combination of hardware, software, and/or firmware. For example, the tagging circuitry 128 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example usage comparison circuitry 130 compares the usage pattern defined by the first accesses of the example cloud resource with a second usage pattern corresponding to historical accesses of reference cloud resources associated with the business environment. In other words, the example usage comparison circuitry 130 compares user activity of the example cloud resource with user activity of reference cloud resources, wherein the example cloud resource and the reference cloud resources are associated with the same business environment (e.g., production, development, etc.). In some examples, the usage comparison circuitry 130 obtains the historical accesses from the EDS 112.

In some examples, the usage comparison circuitry 130 compares CPU utilization of the example cloud resource with CPU utilization (e.g., average CPU utilization) of the reference cloud resources. In some examples, the usage comparison circuitry 130 compares cost metrics of the example cloud resource with cost metrics of the reference cloud resources. Further, the example usage comparison circuitry 130 may notify a user of the example cloud resource that the cost metrics associated with the first accesses have exceeded the cost metrics of the historical accesses. In some examples, the usage comparison circuitry 130 compares a geographical location associated with the first accesses of the example cloud resource with a geographical location associated with the historical accesses. In some examples, the usage comparison circuitry 130 is instantiated by programmable circuitry executing comparison instructions and/or configured to perform operations such as those represented by the flowchart of FIG. 5.

In some examples, the resource manager circuitry 101 includes means for comparing. For example, the means for comparison may be implemented by usage comparison circuitry 130. In some examples, the usage comparison circuitry 130 may be instantiated by programmable circuitry such as the example programmable circuitry 612 of FIG. 6. For instance, the usage comparison circuitry 130 may be instantiated by the example microprocessor 700 of FIG. 7 executing machine executable instructions such as those implemented by at least blocks 504 and 506 of FIG. 5. In some examples, the usage comparison circuitry 130 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the usage comparison circuitry 130 may be instantiated by any other combination of hardware, software, and/or firmware. For example, the usage comparison circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example resource adjustment circuitry 132 adjusts (e.g., limits, restricts, etc.) second accesses (e.g., future accesses, additional accesses, subsequent accesses, etc.) of the example cloud resource. In some examples, when the first usage pattern is different from the second usage pattern, the resource adjustment circuitry 132 can limit the second accesses of the example cloud resource. For example, when the second usage pattern indicates that the historical accesses of the reference cloud resources included user credentials and the first usage pattern indicates that the first accesses of the example cloud resource may not have included user credentials, then the first usage pattern is different from the second usage pattern and the resource adjustment circuitry 132 can limit the second accesses of the example cloud resource based on the second usage pattern. In particular, the example resource adjustment circuitry 132 can prompt a user to enter credentials to authorize the second accesses of the example cloud resource.

In some examples, when the second usage pattern indicates that the historical accesses of the reference cloud resources occurred during a first daytime (e.g., business hours, 8:00 AM to 5:00 PM) and the first usage pattern indicates that the first accesses of the example cloud resource occurred both during the first daytime and a second daytime (e.g., after business hours 5:00 PM to 10:00 PM), then the first usage pattern is different from the second usage pattern and the resource adjustment circuitry 132 can limit the second accesses based on the second usage pattern. In particular, the example resource adjustment circuitry 132 can restrict access to the example cloud resource after business hours.

In some examples, when the second usage pattern indicates that the historical accesses of the reference cloud resources are associated with a first geographical location (e.g., the US) and the first usage pattern indicates that the first accesses are associated with the first geographical location and a second geographical location (e.g., the EU), then the first usage pattern is different than the second usage pattern and the resource adjustment circuitry 132 can limit the second accesses based on the second usage pattern. In particular, the example resource adjustment circuitry 132 can restrict accesses of the example cloud resource from the second geographical location. In some examples, the resource adjustment circuitry 132 is instantiated by programmable circuitry executing resource adjustment instructions and/or configured to perform operations such as those represented by the flowchart of FIG. 5.

In some examples, the resource manager circuitry 101 includes means for adjusting. For example, the means for adjusting may be implemented by resource adjustment circuitry 132. In some examples, the resource adjustment circuitry 132 may be instantiated by programmable circuitry such as the example programmable circuitry 612 of FIG. 6. For instance, the resource adjustment circuitry 132 may be instantiated by the example microprocessor 700 of FIG. 7 executing machine executable instructions such as those implemented by at least blocks 508 of FIG. 5. In some examples, the resource adjustment circuitry 132 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the resource adjustment circuitry 132 may be instantiated by any other combination of hardware, software, and/or firmware. For example, the accessor circuitry 126 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the locator circuitry 108 is instantiated by programmable circuitry executing locating instructions and/or configured to perform operations. In some examples, the resource manager circuitry 101 includes first means for determining. For example, the first means for determining may be implemented by locator circuitry 108. In some examples, the locator circuitry 108 may be instantiated by programmable circuitry such as the example programmable circuitry 612 of FIG. 6. For instance, the locator circuitry 108 may be instantiated by the example microprocessor 700 of FIG. 7 executing machine executable instructions. In some examples, the locator circuitry 108 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the locator circuitry 108 may be instantiated by any other combination of hardware, software, and/or firmware. For example, the locator circuitry 108 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the policy determination circuitry 110 is instantiated by programmable circuitry executing policy determination instructions and/or configured to perform operations. In some examples, the resource manager circuitry 101 includes second means for determining. For example, the second means for determining may be implemented by policy determination circuitry 110. In some examples, the policy determination circuitry 110 may be instantiated by programmable circuitry such as the example programmable circuitry 612 of FIG. 6. For instance, the policy determination circuitry 110 may be instantiated by the example microprocessor 700 of FIG. 7 executing machine executable instructions. In some examples, the policy determination circuitry 110 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the policy determination circuitry 110 may be instantiated by any other combination of hardware, software, and/or firmware. For example, the policy determination circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

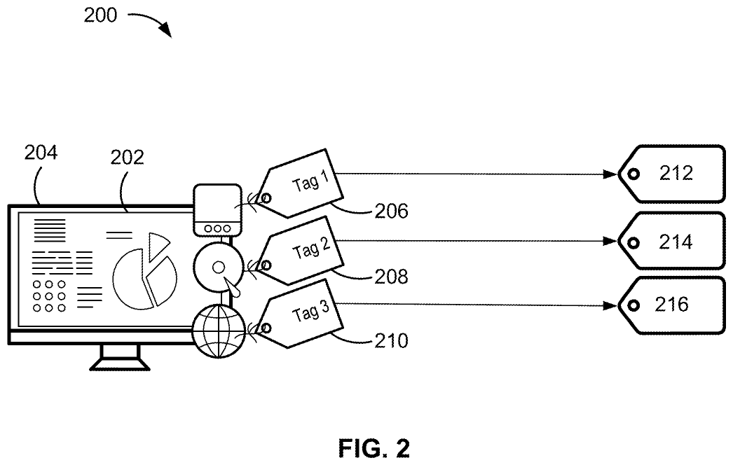

FIG. 2 illustrates an example schematic 200 in accordance with disclosed examples. The example schematic 200 includes an example cloud resource 202 accessed (e.g., deployed) via an example device 204. In this example, the device 204 is implemented as a desktop computer. However, the example device 204 may be implemented by any other type of electronic device, such as a smartphone, a tablet, a laptop computer, etc. The example cloud resource 202 includes example associations or tags 206, 208, 210. In this example, the example cloud resource 202 has three example tags 206, 208, 210. However, the example cloud resource 202 may include any number of tags (e.g., one, two, four, etc.).

The example cloud resource 202 can represent one of the cloud-based resource(s) 102, an EC2 instance, an S3 bucket, etc. The example accessor circuitry 126 can obtain first accesses to the cloud resource 202. In some examples, the files or data associated with the first accesses can relate to financial services (e.g., banking data or activities). For example, employees who work for a financial services company may access the example cloud resource 202 to save or edit files (e.g., banking statements, loan data, customer information, etc.). As such, the example tagging circuitry 128 can associate the example cloud resource 202 with a financial services business environment. In other words, the example tagging circuitry 128 can tag the cloud resource 202 with a “finance tag,” shown in FIG. 2 as the finance tag 206.

In some examples, the tagging circuitry 128 associates the cloud resource 202 with a data security classification. For example, some user accounts associated with the cloud resource 202 may be authorized to access customer data (e.g., customer routing numbers, customer credit card numbers, etc.) while other accounts may not be authorized to access such sensitive data. The first example accesses to the cloud resource 202 may indicate that login credentials are needed to access the data using the cloud resource 202. Accordingly, the example tagging circuitry 128 can associate the cloud resource 202 with a data security classification of “confidential.” In other words, the example tagging circuitry 128 can tag the example cloud resource 202 with a “confidential tag,” shown in FIG. 2 as the confidential tag 208.

In some examples, the example locator circuitry 108 can determine a location of the device 204. The locator circuitry 108 can access an IP address or other device identifier to determine a location corresponding to the device 204 and the first accesses to the cloud resource 202. For example, the locator circuitry 108 can obtain the IP address corresponding to the device 204 and determine that the IP address is registered with an EU based device. As such, the tagging circuitry 128 can associate the cloud resource 202 with an EU location. In other words, the example tagging circuitry 128 can tag the example cloud resource 202 with an “EU tag,” shown in FIG. 2 as the EU tag 210. In some examples, the locator circuitry 108 can determine that the IP address associated with the first accesses of the cloud resource 202 is not included in a list of approved IP addresses for accessing the cloud resource 202 (e.g., a company may require employees to access the cloud resource 202 via company-approved devices). As such, the tagging circuitry 128 can associate the cloud resource 202 with a “device tag.”

The example policy determination circuitry 110 can determine enforcement instructions based on the tags 206, 208, 210. For example, the policy determination circuitry 110 can determine example enforcement instructions 212 for the cloud resource 202 in compliance with the PCI-DSS standards based on the finance tag 206. Additionally, the policy determination circuitry 110 can determine example enforcement instructions 214 for the cloud resource 202 in compliance with user credentials or access codes based on the confidential tag 208. Further, the policy determination circuitry 110 can determine example enforcement instructions 216 for the cloud resource 202 in compliance with EU data security regulations (e.g., GDPR standards) based on the EU tag 210.

The example usage comparison circuitry 130 can compare the first usage pattern (defined by the first accesses of the cloud resource 202) with the second usage pattern corresponding to the historical accesses of the reference cloud resources associated with the financial services business environment or the finance tag 206. The historical accesses of the reference cloud resources associated with the finance tag 206 may be stored in the EDS 112. Additionally, the EDS 112 may include a second usage pattern associated with previous user activity of the reference cloud resources associated with the finance tag 206 (hereafter referred to as financial cloud resources). In some examples, the second usage pattern can indicate that the historical accesses of the financial cloud resources occurred primarily during business hours (e.g., 8:00 AM to 5:00 PM). In some examples, the second usage pattern may represent an industry standard because employees are more likely to access these cloud resources during normal business hours or may be discouraged from accessing these cloud resources or sensitive customer data after business hours. When the first usage pattern associated with the cloud resource 202 indicates that the first accesses of the cloud resource 202 occurred both during business hours and after business hours, then the first usage pattern is different from the second usage pattern and the resource adjustment circuitry 132 can limit second accesses to the cloud resource 202 based on the second usage pattern. In particular, the example resource adjustment circuitry 132 can restrict (e.g., prevent) at least one future access to the cloud resource 202 that occurs after business hours. Additionally, the resource adjustment circuitry 132 can enforce the enforcement instructions 212, 214, 216 on the cloud resource 202.

In some examples, the first accesses of the cloud resource 202 indicate an owner of the cloud resource 202. For example, a user account can create cloud resources, such as the cloud resource 202, on the example device 204. As such, the user account may be an “owner” of the cloud resource 202. The example tagging circuitry 128 may associated the cloud resource 202 with owner identification or an “owner tag.” In some examples, the owner tag may include user identification (e.g., name, department, project, etc.). In some examples, the owner tag may necessitate certain credentials or login information to permit access to the cloud resource 202. Accordingly, the example resource manager circuitry 101 can prevent the second accesses of the cloud resource 202 unless the user provides the credentials. Additionally or alternatively, the “owner” or creator of the cloud resource 202 may also generate (e.g., create, associate, etc.) tags for the cloud resource 202. For example, the owner may intend to use the cloud resource 202 for financial services and tag the cloud resource 202 with the finance tag 206.

In some examples, at least one of the tags 206, 208, 210 may include an expiration date. For example, the confidential tag 208 may indicate that accesses to the cloud resource 202 are limited to a time period (e.g., one hour, one week, one month, etc.). As such, the example resource adjustment circuitry 132 can limit the second accesses to the cloud resource 202 based on the time period or expiration date. In particular, the example resource adjustment circuitry 132 can prevent the second accesses to the cloud resource 202 after time period or the expiration date.

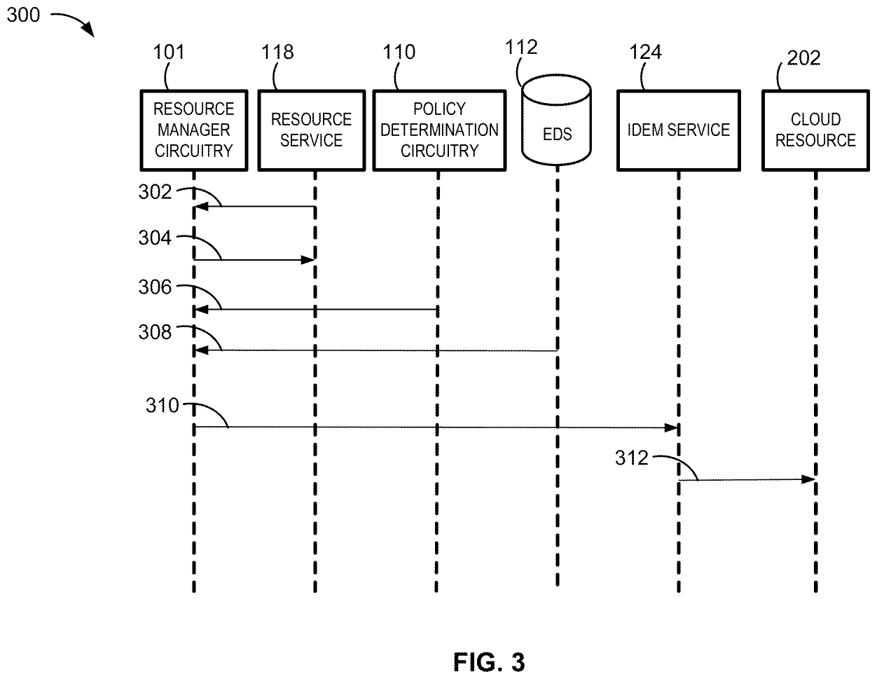

FIG. 3 is an example sequence diagram 300 constructed in accordance with examples disclosed herein. The example sequence diagram 300 begins at step 302 as the resource manager circuitry 101 obtains the first accesses to the cloud resource 202 from the resource service 118. The first example accesses to the cloud resource 202 include files or data pertaining to an example business environment (e.g., financial services, healthcare, etc.). The example resource manager circuitry 101 can tag the cloud resource 202 with the corresponding business environment tag (e.g., the finance tag 206) based on the first accesses. At step 304, the resource manager circuitry 101 can store (e.g., transmit) the business environment tag or other tag in the resource service 118.

At step 306, the example policy determination circuitry 110 determines enforcement instructions based on the finance tag 206. For example, the policy determination circuitry 110 can determine example enforcement instructions 212 for the cloud resource 202 in compliance with the PCI-DSS standards based on the finance tag 206. In this example, the resource manager circuitry 101 accesses the enforcement instructions 212 from the policy determination circuitry 110.

At step 308, the resource manager circuitry 101 accesses a second usage pattern associated with historical accesses of financial cloud resources from the EDS 112. Thus, the example resource manager circuitry 101 can compare the first usage pattern (defined by the first accesses of the cloud resource 202) with the second usage pattern defined by the historical accesses of the financial cloud resources associated with the financial services business environment or the finance tag 206.

At step 310, the example resource manager circuitry 101 transmits instructions to the IDEM service 124. For example, the resource manager circuitry 101 transmits the enforcement instructions 212 to the IDEM service 124. Further, the example resource manager circuitry 101 transmits instructions to limit second (future) accesses to the cloud resource 202 based on the second usage pattern.

At step 312, the IDEM service 124 may implement these instructions (or desired state changes) with respect to the cloud resource 202.

While an example manner of implementing the resource manager circuitry 101 is illustrated in FIG. 1, one or more of the elements, processes, and/or devices illustrated in FIG. 1 may be combined, divided, re-arranged, omitted, eliminated, and/or implemented in any other way. Further, the example locator circuitry 108, the example policy determination circuitry 110, the example accessor circuitry 126, the example tagging circuitry 128, the example usage comparison circuitry 130, the example resource adjustment circuitry 132, and/or, more generally, the example resource manager circuitry 101 of FIG. 1, may be implemented by hardware alone or by hardware in combination with software and/or firmware. Thus, for example, any of the example locator circuitry 108, the example policy determination circuitry 110, the example accessor circuitry 126, the example tagging circuitry 128, the example usage comparison circuitry 130, the example resource adjustment circuitry 132, and/or, more generally, the example resource manager circuitry 101, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example resource manager circuitry 101 of FIG. 1 may include one or more elements, processes, and/or devices in addition to, or instead of, those illustrated in FIG. 1, and/or may include more than one of any or all of the illustrated elements, processes and devices.

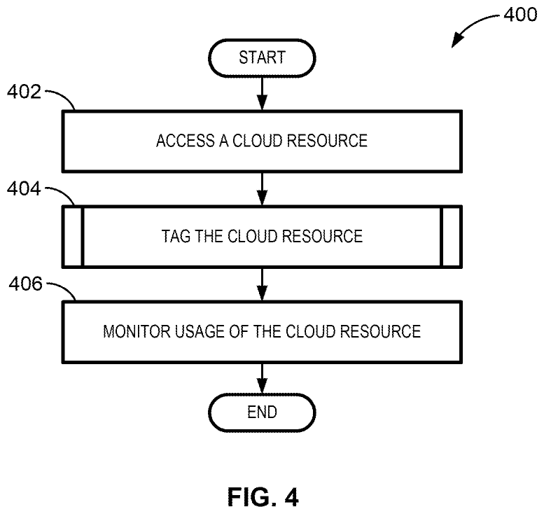

Flowchart(s) representative of example machine readable instructions, which may be executed by programmable circuitry to implement and/or instantiate the resource manager circuitry 101 of FIG. 1 and/or representative of example operations which may be performed by programmable circuitry to implement and/or instantiate the resource manager circuitry 101 of FIG. 1, are shown in FIGS. 4 and 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and 5, many other methods of implementing the example resource manager circuitry 101 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed, instantiated, and/or performed by programmable circuitry to manage a desired state of an example cloud resource. The example machine-readable instructions and/or the example operations 400 of FIG. 4 begin at block 402, at which the resource service 118 accesses information pertaining to the example cloud resource 202. In some examples, the resource service 118 stores and/or manages operational data and/or settings of the cloud resource 202. In some examples, the resource service 118 obtains metadata that correspond to settings, access information and/or configurations of the cloud resource 202.

At block 404, the example resource manager circuitry 101 tags the cloud resource 202, as described in detail in connection with FIG. 5.

At block 406, the example resource service 118 monitors usage of the cloud resource 202. For example, the resource service 118 monitors second accesses of the cloud resource 202 based on adjustments or enforcements generated by the resource manager circuitry 101.

FIG. 5 is a flowchart representative of example machine readable instructions and/or example operations that may be executed, instantiated, and/or performed by programmable circuitry to implement the resource manager circuitry 101, as described above in connection with block 404 of FIG. 4. The example machine readable instructions and/or the operations of FIG. 5 begin at block 500, at which the example accessor circuitry 126 obtains first accesses to an example cloud resource. For example, the accessor circuitry 126 obtains the first accesses to the example cloud resource 202. In this example, the first accesses to the cloud resource 202 include files or data pertaining to financial services.

At block 502, the example tagging circuitry 128 associates the example cloud resource 202 with a business environment based on the first accesses. The first example accesses include files or data pertaining to financial services, so the example tagging circuitry 128 associates the cloud resource 202 with a financial services business environment or the finance tag 206. In some examples, the tagging circuitry 128 associates the cloud resource 202 with a data security classification (e.g., private tag, confidential tag, public tag, etc.) based on the first accesses. In some examples, the tagging circuitry 128 associates the cloud resource 202 with a location tag (e.g., US tag, EU tag, etc.) based on an IP address associated with an example computing device that is accessing the cloud resource 202.

At block 504, the example usage comparison circuitry 130 compares a first usage pattern defined by the first access with a second usage pattern defined by historical accesses of reference cloud resources associated with the business environment. For example, the usage comparison circuitry 130 compares the first usage pattern defined by the first accesses of the cloud resource 202 with a second usage pattern corresponding to the historical accesses of the financial cloud resources associated with the financial services business environment or the finance tag 206.

At block 506, the example usage comparison circuitry 130 determines whether the first usage pattern is different from the second usage pattern. In some examples, the second usage pattern can indicate that the historical accesses of the financial cloud resources occurred primarily during business hours and the first usage pattern can indicate that the first accesses of the cloud resource occurred after business hours. Accordingly, the first usage pattern is different from the second usage pattern and control of the process proceeds to block 508. Otherwise, the process returns to the process 400 of FIG. 4.

At block 508, the example resource adjustment circuitry 132 limits second (future) accesses of the cloud resource 202 based on the comparison. For example, the resource adjustment circuitry 132 can limit second accesses of the cloud resource 202 based on the second usage pattern. In particular, the example resource adjustment circuitry 132 can restrict at least one future access to the cloud resource 202 that occurs after business hours. Then, the process returns to the process 400 of FIG. 4.

FIG. 6 is a block diagram of an example programmable circuitry platform 600 structured to execute and/or instantiate the example machine-readable instructions and/or the example operations of FIGS. 4 and 5 to implement the resource manager circuitry 101 of FIG. 1. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example locator circuitry 108, the example policy determination circuitry 110, the example accessor circuitry 126, the example tagging circuitry 128, the example usage comparison circuitry 130, and the example resource adjustment circuitry 132.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4 and 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4 and 5 to effectively instantiate the circuitry of FIG. 1 as logic circuits to perform operations corresponding to those machine readable instructions. In some such examples, the circuitry of FIG. 1 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4 and 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4 and 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and 5. As such, the FPGA circuitry 800 may be configured and/or structured to effectively instantiate some or all of the operations/functions corresponding to the machine readable instructions of the flowchart(s) of FIGS. 4 and 5 as dedicated logic circuits to perform the operations/functions corresponding to those software instructions in a dedicated manner analogous to an ASIC Therefore, the FPGA circuitry 800 may perform the operations/functions corresponding to the some or all of the machine readable instructions of FIGS. 4 and 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4 and 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4 and 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 4 and 5, and/or an ASIC may be configured and/or structured to perform third operation(s)/function(s) corresponding to a third portion of the machine readable instructions represented by the flowcharts of FIGS. 4 and 5.

It should be understood that some or all of the circuitry of FIG. 1 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 1 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

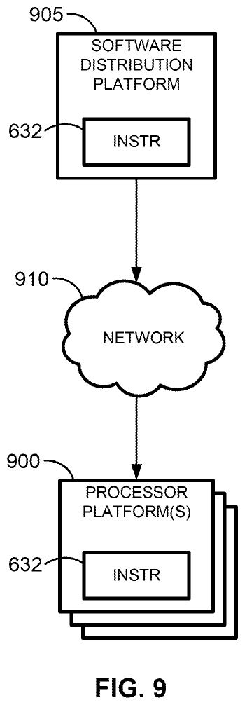

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4 and 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 4 and 5, may be downloaded to the example programmable circuitry platform 600, which is to execute the machine readable instructions 632 to implement the resource manager circuitry 101. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that track, monitor, and manage cloud resources. Examples disclosed herein tag cloud resources to provide a user or an organization with a comprehensive, centralized view of cloud resources. Disclosed systems, apparatus, articles of manufacture, and methods improve the efficiency of using a computing device by enabling a user to identify overuse, duplicative use, security breaches, policy compliance, etc., associated with cloud resources. Disclosed systems, apparatus, articles of manufacture, and methods are accordingly directed to one or more improvement(s) in the operation of a machine such as a computer or other electronic and/or mechanical device.

Example 1 includes an apparatus comprising interface circuitry, machine readable instructions, and programmable circuitry to at least one of instantiate or execute the machine readable instructions to obtain first accesses of a cloud resource, the first accesses defining a first usage pattern associated with the cloud resource, associate the cloud resource with a business environment based on the first accesses, compare the first usage pattern to a second usage pattern corresponding to historical accesses of reference cloud resources associated with the business environment, and when the first usage pattern is different from the second usage pattern, limit second accesses of the cloud resource based on the second usage pattern.

Example 2 includes the apparatus of example 1, wherein the second usage pattern indicates that the historical accesses occurred during a daytime, and wherein the programmable circuitry is to limit the second access to occur during the daytime.

Example 3 includes the apparatus of example 1, wherein the second usage pattern indicates that the historical accesses included user credentials, and wherein the programmable circuitry is to limit the second accesses to include the user credentials.

Example 4 includes the apparatus of example 1, wherein the first usage pattern indicates that the first accesses correspond to a first geographical location and the second usage pattern indicates that the historical accesses correspond to a second geographical location different from the first geographical location, and wherein the programmable circuitry is to limit the second accesses to the second geographical location.

Example 5 includes the apparatus of example 1, wherein the business environment is associated with a data security classification, wherein the programmable circuitry is to associate the cloud resource with the data security classification, and limit the second accesses to the cloud resource based on the data security classification.

Example 6 includes the apparatus of example 1, wherein the programmable circuitry is to obtain enforcement instructions based on the business environment, and limit the second accesses to the cloud resource based on the enforcement instructions.

Example 7 includes the apparatus of example 6, wherein the enforcement instructions include compliance standards of an industry associated with the business environment.

Example 8 includes the apparatus of example 6, wherein the enforcement instructions include compliance standards of a geographical region associated with the cloud resource.

Example 9 includes a non-transitory machine readable storage medium comprising instructions to cause programmable circuitry to at least obtain first accesses of a cloud resource, the first accesses defining a first usage pattern associated with the cloud resource, associate the cloud resource with a business environment based on the first accesses, compare the first usage pattern to a second usage pattern corresponding to historical accesses of reference cloud resources associated with the business environment, and when the first usage pattern is different from the second usage pattern, limit second accesses of the cloud resource based on the second usage pattern.

Example 10 includes the non-transitory machine readable storage medium of example 9, wherein the second usage pattern indicates that the historical accesses occurred during a daytime, and wherein the instructions are to cause the programmable circuitry to limit the second access to occur during the daytime.

Example 11 includes the non-transitory machine readable storage medium of example 9, wherein the second usage pattern indicates that the historical accesses included user credentials, and wherein the instructions are to cause the programmable circuitry to limit the second accesses to include the user credentials.

Example 12 includes the non-transitory machine readable storage medium of example 9, wherein the first usage pattern indicates that the first accesses correspond to a first geographical location and the second usage pattern indicates that the historical accesses correspond to a second geographical location different from the first geographical location, and wherein the instructions are to cause the programmable circuitry to limit the second accesses to the second geographical location.

Example 13 includes the non-transitory machine readable storage medium of example 9, wherein the business environment is associated with a data security classification, wherein the instructions are to cause the programmable circuitry to associate the cloud resource with the data security classification, and limit the second accesses to the cloud resource based on the data security classification.

Example 14 includes the non-transitory machine readable storage medium of example 9, wherein the instructions are to cause the programmable circuitry to obtain enforcement instructions based on the business environment, and limit the second accesses to the cloud resource based on the enforcement instructions.

Example 15 includes the non-transitory machine readable storage medium of example 14, wherein the enforcement instructions include compliance standards of an industry associated with the business environment.

Example 16 includes the non-transitory machine readable storage medium of example 14, wherein the enforcement instructions include compliance standards of a geographical region associated with the cloud resource.

Example 17 includes a method comprising obtaining, by executing an instruction with programmable circuitry, first accesses of a cloud resource, the first accesses defining a first usage pattern associated with the cloud resource, associating, by executing an instruction with the programmable circuitry, the cloud resource with a business environment based on the first accesses, comparing, by executing an instruction with the programmable circuitry, the first usage pattern to a second usage pattern corresponding to historical accesses of reference cloud resources associated with the business environment, and when the first usage pattern is different from the second usage pattern, limiting, by executing an instruction with the programmable circuitry, second accesses of the cloud resource based on the second usage pattern.

Example 18 includes the method of example 17, wherein the second usage pattern indicates that the historical accesses occurred during a daytime, further including limiting, by executing an instruction with the programmable circuitry, the second access to occur during the daytime.

Example 19 includes the method of example 17, wherein the second usage pattern indicates that the historical accesses included user credentials, further including limiting, by executing an instruction with the programmable circuitry, the second accesses to include the user credentials.

Example 20 includes the method of example 17, wherein the first usage pattern indicates that the first accesses correspond to a first geographical location and the second usage pattern indicates that the historical accesses correspond to a second geographical location different from the first geographical location, further including limiting, by executing an instruction with the programmable circuitry, the second accesses to the second geographical location.

Example 21 includes the method of example 17, wherein the business environment is associated with a data security classification, further including associating, by executing an instruction with the programmable circuitry, the cloud resource with the data security classification, and limiting, by executing an instruction with the programmable circuitry, the second accesses to the cloud resource based on the data security classification.

Example 22 includes the method of example 17, further including obtaining, by executing an instruction with the programmable circuitry, enforcement instructions based on the business environment, and limiting, by executing an instruction with the programmable circuitry, the second accesses to the cloud resource based on the enforcement instructions.

Example 23 includes the method of example 22, wherein the enforcement instructions include compliance standards of an industry associated with the business environment.

Example 24 includes the method of example 22, wherein the enforcement instructions include compliance standards of a geographical region associated with the cloud resource.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
obtain first accesses of a cloud resource, the first accesses defining a first usage pattern associated with the cloud resource;
associate the cloud resource with a business environment based on the first accesses;
compare the first usage pattern to a second usage pattern corresponding to historical accesses of reference cloud resources associated with the business environment; and
when the first usage pattern is different from the second usage pattern, limit second accesses of the cloud resource based on the second usage pattern.

2. The apparatus of claim 1, wherein the second usage pattern indicates that the historical accesses occurred during a daytime, and wherein the programmable circuitry is to limit the second access to occur during the daytime.

3. The apparatus of claim 1, wherein the second usage pattern indicates that the historical accesses included user credentials, and wherein the programmable circuitry is to limit the second accesses to include the user credentials.

4. The apparatus of claim 1, wherein the first usage pattern indicates that the first accesses correspond to a first geographical location and the second usage pattern indicates that the historical accesses correspond to a second geographical location different from the first geographical location, and wherein the programmable circuitry is to limit the second accesses to the second geographical location.

5. The apparatus of claim 1, wherein the business environment is associated with a data security classification, wherein the programmable circuitry is to:
associate the cloud resource with the data security classification; and
limit the second accesses to the cloud resource based on the data security classification.

6. The apparatus of claim 1, wherein the programmable circuitry is to:
obtain enforcement instructions based on the business environment; and
limit the second accesses to the cloud resource based on the enforcement instructions.

7. The apparatus of claim 6, wherein the enforcement instructions include compliance standards of an industry associated with the business environment.

8. The apparatus of claim 6, wherein the enforcement instructions include compliance standards of a geographical region associated with the cloud resource.

9. A non-transitory machine readable storage medium comprising instructions to cause programmable circuitry to at least:
obtain first accesses of a cloud resource, the first accesses defining a first usage pattern associated with the cloud resource;
associate the cloud resource with a business environment based on the first accesses;
compare the first usage pattern to a second usage pattern corresponding to historical accesses of reference cloud resources associated with the business environment; and
when the first usage pattern is different from the second usage pattern, limit second accesses of the cloud resource based on the second usage pattern.

10. The non-transitory machine readable storage medium of claim 9, wherein the second usage pattern indicates that the historical accesses occurred during a daytime, and wherein the instructions are to cause the programmable circuitry to limit the second access to occur during the daytime.

11. The non-transitory machine readable storage medium of claim 9, wherein the second usage pattern indicates that the historical accesses included user credentials, and wherein the instructions are to cause the programmable circuitry to limit the second accesses to include the user credentials.

12. The non-transitory machine readable storage medium of claim 9, wherein the first usage pattern indicates that the first accesses correspond to a first geographical location and the second usage pattern indicates that the historical accesses correspond to a second geographical location different from the first geographical location, and wherein the instructions are to cause the programmable circuitry to limit the second accesses to the second geographical location.

13. The non-transitory machine readable storage medium of claim 9, wherein the business environment is associated with a data security classification, wherein the instructions are to cause the programmable circuitry to:
associate the cloud resource with the data security classification; and
limit the second accesses to the cloud resource based on the data security classification.

14. The non-transitory machine readable storage medium of claim 9, wherein the instructions are to cause the programmable circuitry to:
obtain enforcement instructions based on the business environment; and
limit the second accesses to the cloud resource based on the enforcement instructions.

15. The non-transitory machine readable storage medium of claim 14, wherein the enforcement instructions include compliance standards of an industry associated with the business environment.

16. The non-transitory machine readable storage medium of claim 14, wherein the enforcement instructions include compliance standards of a geographical region associated with the cloud resource.

17. A method comprising:
obtaining, by executing an instruction with programmable circuitry, first accesses of a cloud resource, the first accesses defining a first usage pattern associated with the cloud resource;
associating, by executing an instruction with the programmable circuitry, the cloud resource with a business environment based on the first accesses;
comparing, by executing an instruction with the programmable circuitry, the first usage pattern to a second usage pattern corresponding to historical accesses of reference cloud resources associated with the business environment; and
when the first usage pattern is different from the second usage pattern, limiting, by executing an instruction with the programmable circuitry, second accesses of the cloud resource based on the second usage pattern.

18. The method of claim 17, wherein the second usage pattern indicates that the historical accesses occurred during a daytime, further including limiting, by executing an instruction with the programmable circuitry, the second access to occur during the daytime.

19. The method of claim 17, wherein the second usage pattern indicates that the historical accesses included user credentials, further including limiting, by executing an instruction with the programmable circuitry, the second accesses to include the user credentials.

20. The method of claim 17, wherein the first usage pattern indicates that the first accesses correspond to a first geographical location and the second usage pattern indicates that the historical accesses correspond to a second geographical location different from the first geographical location, further including limiting, by executing an instruction with the programmable circuitry, the second accesses to the second geographical location.

21. The method of claim 17, wherein the business environment is associated with a data security classification, further including:
associating, by executing an instruction with the programmable circuitry, the cloud resource with the data security classification; and
limiting, by executing an instruction with the programmable circuitry, the second accesses to the cloud resource based on the data security classification.

22. The method of claim 17, further including:
obtaining, by executing an instruction with the programmable circuitry, enforcement instructions based on the business environment; and
limiting, by executing an instruction with the programmable circuitry, the second accesses to the cloud resource based on the enforcement instructions.

23. The method of claim 22, wherein the enforcement instructions include compliance standards of an industry associated with the business environment.

24. The method of claim 22, wherein the enforcement instructions include compliance standards of a geographical region associated with the cloud resource.
